(19) United States
(12) Patent Application Publication
(10) Pub. No.: US 2009/0276709 A1
(43) Pub. Date: Nov. 5, 2009

(54) METHOD AND APPARATUS FOR PROVIDING DYNAMIC PLAYLISTS AND TAG-TUNING OF MULTIMEDIA OBJECTS

(76) Inventors: Brian VENNEMAN, Mountain View, CA (US); Ian David White, San Francisco, CA (US); Arin Sarkissian, San Mateo, CA (US)

Correspondence Address: PILLSBURY WINTHROP SHAW PITTMAN LLP, P.O. BOX 10500, MCLEAN, VA, 22102, US

(21) Appl. No.: 12/434,570

(22) Filed: May 1, 2009

Related U.S. Application Data
(60) Provisional application No. 61/049,745, filed on May 1, 2008.
(60) Provisional application No. 61/112,471, filed on Nov. 7, 2008.

(51) Int. Cl. G06F 3/00

(52) U.S. Cl. 715/716

(57) ABSTRACT

A user may post items that are associated with multimedia objects, such as audio files and video files. The posted items are automatically added to the dynamic playlists of other users who are “following” the user. A user's dynamic playlist is provided to that user for viewing and for accessing the multimedia objects associated with the items in the dynamic playlist. One user may give another user a particular amount of social currency, and a particular's user's total amount of social currency received through gifts is maintained and displayed in a profile of the particular user. A user may create and modify certain tag settings that are used to filter a plurality of multimedia objects such that only the multimedia objects that satisfy the user's tag settings are provided to the user.

### CROSS-REFERENCE TO RELATED APPLICATIONS

The present application claims priority to U.S. Provisional Appln. No. 61/049,745, filed on May 1, 2008, and U.S. Provisional Appln. No. 61/112,471, filed on Nov. 7, 2008, the contents of which are incorporated by reference herein in their entirety.

### FIELD OF THE INVENTION

The present invention relates to online services and communication tools, and specifically to playlists and tagging of multimedia objects.

### BACKGROUND OF THE INVENTION

Microblogging services, such as Twitter from Twitter, Inc., located in San Francisco, Calif., allow a user to “follow” bloggers by electing to receive blog updates from the bloggers. Typically only the blog updates from the bloggers that have been selected by the user are received by the user. Blog updates comprise only text and may be limited in size (e.g., 140 characters).

Internet radio stations, such as those available from iTunes, from Apple Inc. in Cupertino, Calif., allow a user to receive music from any one of many radio stations. Beyond the choice of the radio station, however, the user does not have other ways of customizing the music being received.

On blogs, readers are typically allowed to comment on the blog author's entries. However, there is currently no way through which a reader can assess the quality of a blog through quantitative indicators.

### SUMMARY OF THE INVENTION

According to one aspect of the invention, a particular user may post items that are associated with multimedia objects, such as audio files and video files. The posted items are automatically added to the dynamic playlists of other users who are “following” the particular user. The posted items may also be added to the particular user's own dynamic playlist. The dynamic playlist of any user is provided to that user for viewing and for accessing the multimedia objects associated with the items in the dynamic playlist.

According to another aspect of the invention, one user may give another user a particular amount of social currency, and a particular's user's total amount of social currency received through gifts is maintained and displayed in a profile of the particular user.

According to another aspect of the invention, a user may create and modify certain tag settings. A user's tag settings are then used to filter a plurality of multimedia objects such that only the multimedia objects that satisfy the user's tag settings are provided to the user.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram illustrating an exemplary user interface for a dynamic playlist.

FIG. 2 illustrates a user interface that includes search box.

FIG. 3 illustrates a user interface that includes recommendation window.

FIG. 4 illustrates a user interface that includes an icon for giving a “props”.

FIG. 5 illustrates a exemplary user profile.

FIG. 6 illustrates a user interface that displays a listing of a particular user's publisher users.

FIG. 7 illustrates a user interface that displays a listing of a particular user's follower users.

FIG. 8 is a block diagram illustrating an exemplary user interface for tag cloud tuning.

### DETAILED DESCRIPTION

According to one aspect of the invention, a user may post items that are associated with multimedia objects, such as audio files and video files. The posted items are automatically added to the dynamic playlists of other users who are “following” the user. The posted items may also be added to the user's own dynamic playlist. A user's dynamic playlist is provided to that user for viewing and for accessing the multimedia objects associated with the items in the dynamic playlist.

A posted item will also be referred to herein as a “dynamic playlist item”. A first user is considered to be “followed” by a second user if the second user has previously selected the first user as someone to be “followed”. In other words, the second user has selected the first user as a “publisher” such that the first user's postings of dynamic playlist items are added on to the second user's own dynamic playlist.

For clarity, in the following description, the first user who has been selected as a “publisher” by the second user will be referred to as a “publisher user”, and the second user who is following the first user will be referred to as a “follower user”. It should be apparent to persons skilled in the art that a single user may be both a “publisher user” and a “follower user” vis-à-vis other users, though the examples below discuss one user as a “publisher user” and another user as a “follower user”.

When a publisher user has posted a dynamic playlist item, the dynamic playlist item is added to a dynamic playlist associated with the follower user. The dynamic playlist associated with the follower user is also referred to as the follower user's dynamic playlist. The follower user's dynamic playlist is provided to the follower user. The dynamic playlist item may also be automatically added to a dynamic playlist associated with the publisher user (i.e. the publisher user's dynamic playlist).

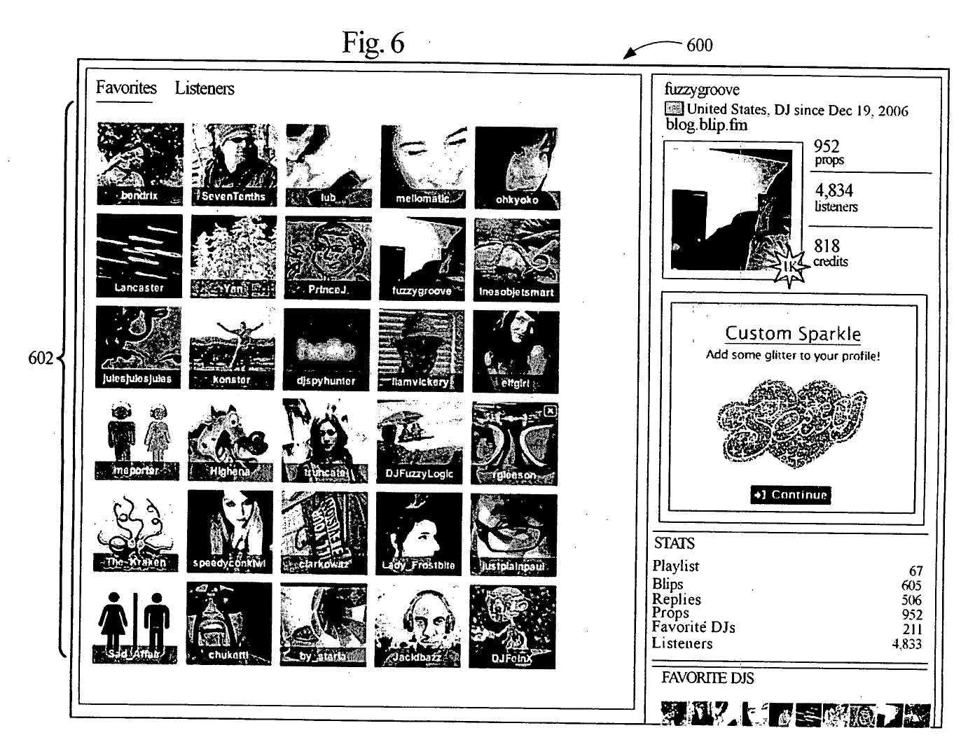

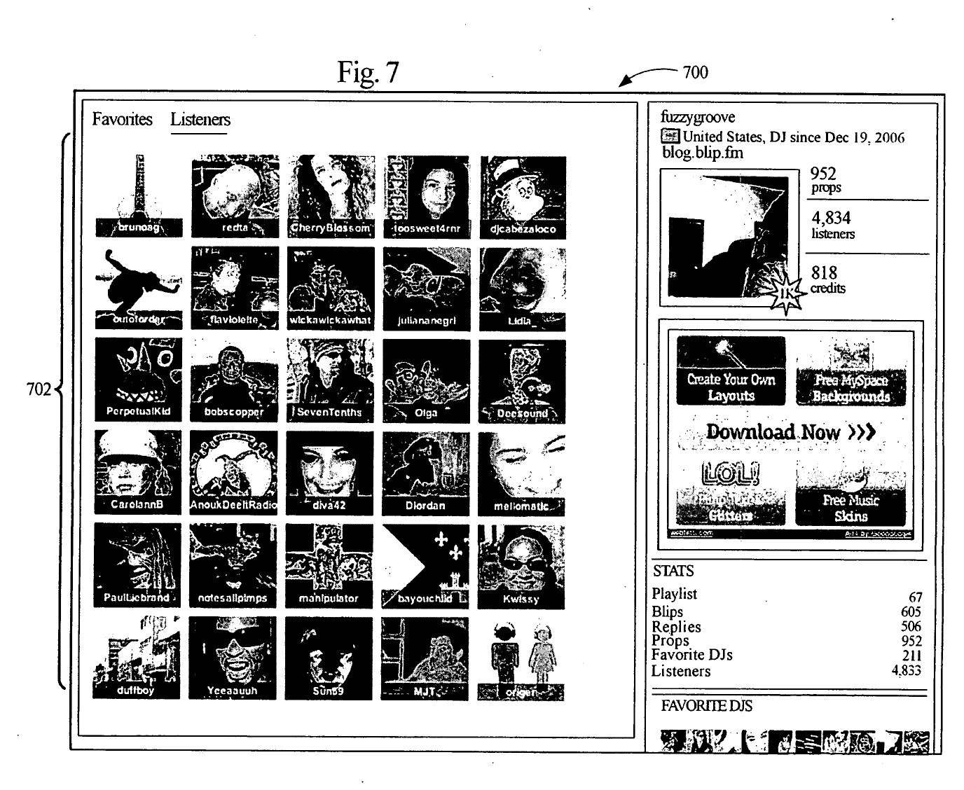

It should be apparent that the publisher user may have other follower users. That is, multiple users may have selected the publisher user as a publisher. When the publisher user posts a dynamic playlist item, the dynamic playlist item is added to the dynamic playlists of all users who have selected the publisher user as a publisher. It should also be apparent that the follower user may be following other publisher users. That is, the follower user may have selected multiple users as publishers. For example, FIG. 6 illustrates an interface 600 that displays a listing 602 of a particular user's publisher users, and FIG. 7 illustrates an interface 700 that displays a listing 702 of users who are follower users of the particular user.

When any user who has been selected as a publisher by the follower user posts a dynamic playlist item, the dynamic playlist item is added to the follower user's dynamic playlist. The follower user's dynamic playlist may also be referred to as the follower user's personal dynamic playlist. According to one embodiment, a user may also be provided with access to a public dynamic playlist, where the public dynamic playlist includes the posted dynamic playlist items from all users.

A follower user may update his or her selections of users as publishers at any time to add or remove users as publishers. Upon receipt of an indication from a follower user that he or she wishes to update the selection of publishers, the updated selection is saved and may be retrieved in the future to determine which users were selected as publishers by the follower user. In one embodiment, the identity of users who were selected by a follower user to be publishers may be received from a social network. For example, a follower user may indicate that he or she wishes to select all “friends” from a social network (e.g., Facebook from Facebook, Inc. in Palo Alto, Calif.) as publishers.

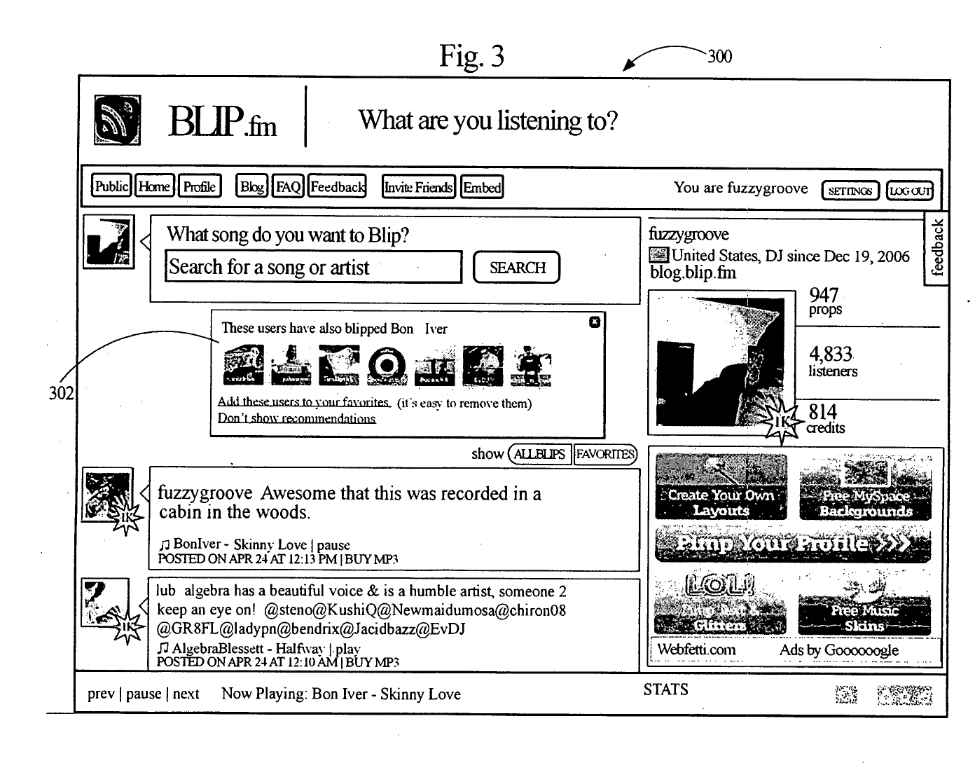

In addition, recommendations of new “publisher users” may be automatically generated for a particular user based on the particular user's current selection of “publisher users”, the particular user's own posted dynamic playlist items, and the dynamic playlist items that the particular user has added to a static playlist (static playlists are described in detail later in this discussion). For example, based on the particular user's single or frequent posting of dynamic playlist items whose associated multimedia objects are songs by artist XYZ, a recommendation may be automatically generated that recommends user 123 as a “publisher user” for the particular user if user 123 also at one time or frequently posts dynamic playlist items containing songs by artist XYZ. FIG. 3 illustrates an interface 300 that includes recommendation window 302 that includes a list of the avatars of users that are recommended to be “publisher users” to a particular user, based on the particular user's posting of dynamic playlist items related to “Bon Iver”.

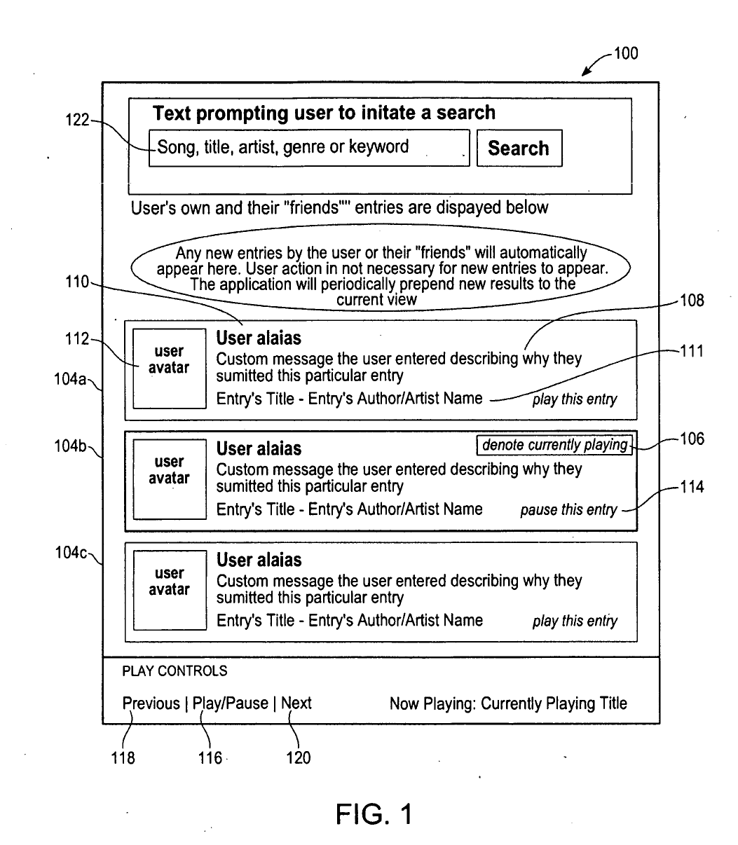

A user's dynamic playlist is provided to the user. According to one aspect of the present invention, the dynamic playlist is self-updating, or self-refreshing, so that new dynamic playlist items are provided to the user without the user's active request for new items. The dynamic playlist may be provided as display data so that the dynamic playlist is displayed on the user's client device. For example, the user's client device may be a personal computer (PC), and the display data may be data that can be displayed on a web page in a browser program on the PC. The client device may also be a mobile device such as a mobile telephone, a gaming device (a home gaming device or a mobile gaming device), a television set-top box, etc. FIG. 1 illustrates an exemplary user interface 100 that may be generated based on provided display data. User interface 100 includes a display of dynamic playlist 102, which in turn includes dynamic playlist items 104a, 104b, and 104c.

A dynamic playlist item may also comprise an accompanying note, where the accompanying note is written by the publisher user who posted the dynamic playlist item. For example, the publisher user may comment on the associated multimedia object to give some information about the associated multimedia object to the follower users (e.g., “If you like artist ABC, then check this out.”). The accompanying note may comprise text, as in the example, or may additionally or alternatively comprise multimedia objects, such as audio and video multimedia objects, or hyperlinks to other objects. In addition, the dynamic playlist item may also comprise a user name and/or an avatar of the publisher user, so that follower users may be able to identify who posted the dynamic playlist item. Also, the dynamic playlist item may comprise information about the associated multimedia object. For example, if the multimedia object is an audio file of a song, then the information may include the song's title and the song's artist.

A dynamic playlist item's accompanying note, publisher user user name, publisher user avatar, and multimedia object information may also be displayed within the displayed dynamic playlist item provided to a user. For example, in user interface 100, dynamic playlist item 104a includes accompanying message 108, publisher user user name 110, publisher user avatar 112, and multimedia object information 111.

In addition to or in alternative to providing data to display a dynamic playlist, data from a multimedia object associated with a dynamic playlist item in the dynamic playlist may be provided to the user. For example, if the multimedia object is an audio file such as an MP3 file, the MP3 file may be sent to the user's client device. Additionally or alternatively, information on how to retrieve the multimedia object (e.g., metadata indicating a location from which the multimedia object may be retrieved) may be provided to the client device. Using the provided location information, the client device may separately retrieve the multimedia object. Data from the multimedia object may be provided to the user by sending the data to the user's client device or streaming the data to the user's client device. The sending of data may be performed by a server that also provides the dynamic playlist, or may be performed by a third-party server. Further details about implementation of aspects of the present invention with servers will be discussed later. It should also be apparent that the multimedia objects associated with dynamic playlist items can be any multimedia object, including but not limited to audio files (e.g., MP3, WAV, WMA, ACC files, etc.), video files (e.g., MOV, MP4, RealMedia files, etc.), and image files (JPEG, TIFF files, etc.).

According to one embodiment, a user's dynamic playlist contains a “currently playing dynamic playlist item”. A currently playing dynamic playlist item is a dynamic playlist item whose associated multimedia object's data is currently being provided to the user. The currently playing dynamic playlist item may be the dynamic playlist item that was most recently added to the user's dynamic playlist.

When a dynamic playlist item is added to a user's dynamic playlist, it may be prepended to the user's dynamic playlist so that the topmost dynamic playlist item on the user's dynamic playlist is the most recently added dynamic playlist item. In user interface 100, for example, dynamic playlist item 104a is the most topmost dynamic playlist item in dynamic playlist 102, and is also the most recently added dynamic playlist item if newly added dynamic playlist items are prepended to dynamic playlist 102. In a dynamic playlist where newly added dynamic playlist items are prepended, the dynamic playlist may also be sorted in a reverse chronological order according to timestamps that indicate when a dynamic playlist item was added to the dynamic playlist.

The currently playing dynamic playlist item may also be any dynamic playlist item besides the most recently added dynamic playlist item. For example, in the example illustrated in user interface 100, the currently playing dynamic playlist item is dynamic playlist item 106a, where dynamic playlist item 106a is not the most recently added dynamic playlist item.

A user may request that the currently playing dynamic playlist item pause playing. For example, in user interface 100, controls 114 and 116 are controls that the user can use to pause the playing of the currently playing dynamic playlist item. Upon receipt of an indication that a user wishes to pause playing, the providing of data from the multimedia object is paused. For example, the sending or streaming of the data is stopped. The user may also resume the playing of the currently playing dynamic playlist item by using controls such as controls 114 and 116. Upon receipt of an indication that a user wishes to resume playing, data from the multimedia object is provided to the user again. A dynamic playlist may be said to be “playing” when the currently playing dynamic playlist item is playing.

In addition, a user may “fast forward” and “reverse” the playing of a dynamic playlist by using controls such as control 118 and control 120. Control 118 enables a user to indicate that he or she wishes to play a previous dynamic playlist item, and control 120 enables a user to indicate that he or she wishes to play a next dynamic playlist item. A dynamic playlist may be an ordered list, such that a previous dynamic playlist item is a dynamic playlist item that is immediately before the currently playing dynamic playlist item in the dynamic playlist and a next dynamic playlist item is a dynamic playlist item that is immediately after the currently playing dynamic playlist item. As discussed above, a dynamic playlist may be ordered according to timestamps that indicate times that dynamic playlist items in the dynamic playlist were added, and may be sorted in a reverse-chronological order. In other embodiments, the dynamic playlist items may be sorted in chronological order or in any other order, including alphabetically by user names of the publisher users, by the number of times the dynamic playlist item has been added in the past, etc.

Once a dynamic playlist item posted by a publisher user has been added to the dynamic playlist of a follower user, the follower user may post a message in reply to the publisher user's posting of the dynamic playlist item. For example, after listening to an audio file associated with the dynamic playlist item, the follower user may wish to communicate his or her thoughts on the audio file to the publisher user. In an user interface provided to the follower user, the follower user may use a control that generates a “reply window” or “reply box” in which the follower user can enter in a comment. The comment entered is then sent to the publisher user and may include information that indicates that the comment pertains to the posted dynamic playlist item. The comment may also be displayed as part of the publisher user's dynamic playlist. In another example, a follower user may use a control that generates a “message window” or “message box”, in which the follower user may direct the message to any user (e.g., by entering “@<username>”, where <username> indicates the user name of the user who is to receive the message). In addition, the user may also post a dynamic playlist item with “@<username>” in the associated message.

Once a dynamic playlist item posted by a publisher user has been added to the dynamic playlist of a follower user, the follower user may also “repost” the dynamic playlist item. When the follower user reposts a dynamic playlist item, the dynamic playlist item will be added to the dynamic playlists of other users who are followers of the follower user. In addition, the reposted dynamic playlist item may also comprise information that indicates that the dynamic playlist item was reposted and information about the original publisher user, which may be displayed with the dynamic playlist item in dynamic playlists.

A user interface that displays a dynamic playlist with dynamic playlist items may also display, for the dynamic playlist items, links to websites on which products associated with the dynamic playlist items may be purchased. For example, if a dynamic playlist item is associated with an audio file, and the audio file is a song, then a link may be displayed with the dynamic playlist item such that a user clicking on the link will be able to access a website that sells an album that contains the song in the audio file.

Once a dynamic playlist item posted by a publisher user has been added to the dynamic playlist of a follower user, the follower user may also add the dynamic playlist item to the follower user's “static” playlist. A static playlist is associated with a particular user, and may be accessed by the particular user at any point in time. Once a dynamic playlist item has been added to a user's static playlist, the user may later access the static playlist to play the dynamic playlist item. Although the user may also access the dynamic playlist item from the dynamic playlist, the user may wish to view only certain dynamic playlist items (e.g., dynamic playlist items that the user especially likes), so by selectively adding certain dynamic playlist items to the static playlist, the user can easily view just the selected dynamic playlist items. Also, a user's dynamic playlist may be limited in size. For example, a dynamic playlist may be configured to include only the 20, 50, or 100 dynamic playlist items that were most recently added. In this case, the user may not be able to access certain dynamic playlist items after a period of time. By adding the certain dynamic playlist items to the static playlist, however, the user will be able to access these items at any point in time. Multiple static playlists may be created by and maintained for a single user. When a user adds a dynamic playlist item to a static playlist, he may select which static playlist or static playlists to add the dynamic playlist item to.

To post a dynamic playlist item, a publisher user may perform a search for multimedia objects. For example, user interface 100 includes a search box 122, in which a publisher user may enter in a query. Search results are then provided to the publisher user, and the publisher user may then select one of the search results, and post a dynamic playlist item that is associated with a multimedia object in the selected search result. A database of multimedia objects may be maintained and accessed in providing search results to the user. An alternative search may be performed using available on-line search engines, where the alternative search is based on the user-entered search and the search results from the alternative search are analyzed and reformatted into a formatted set of search results to be provided to the user.

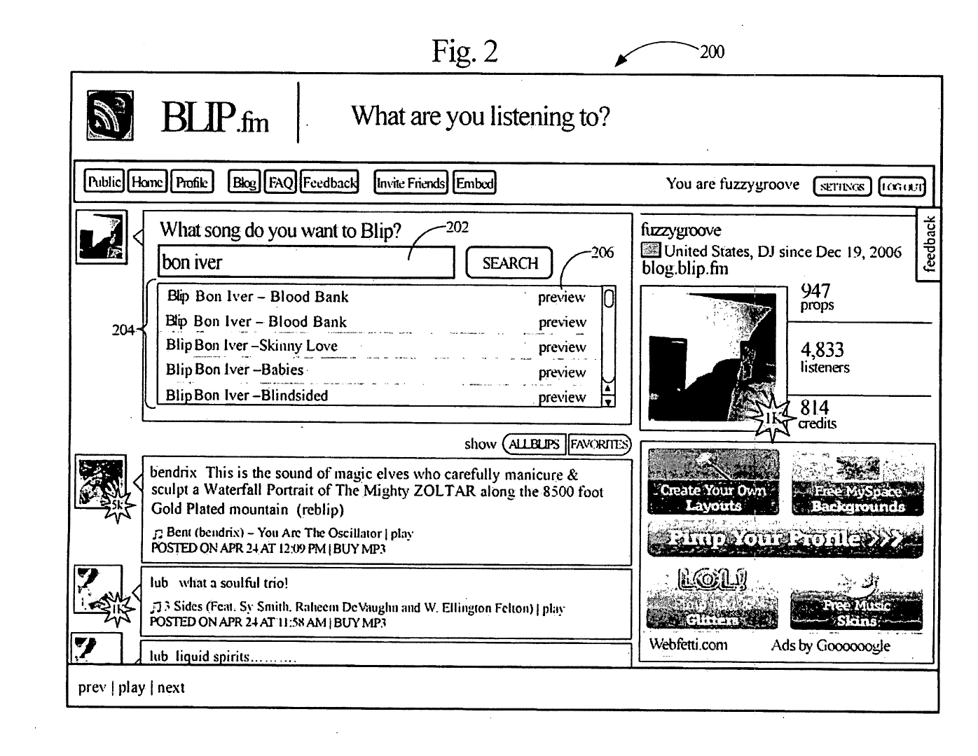

FIG. 2 illustrates user interface 200, which includes search box 202. A search entered into search box 202 resulted in search results 204. According to one embodiment, a user may preview a search result by interacting with a preview interface (e.g., preview button 206) to preview the multimedia object of the search result. In the example in FIG. 2, a user's selection of preview button 206 will result in the playing of a clip from the “Bon Iver—Blood Bank” audio file.

According to another aspect of the invention, one user may give another user a particular amount of social currency, and a particular user's total amount of social currency received through gifts is maintained and displayed in a profile of the particular user. In addition, social currency may be used to purchase certain items and/or features, such as access to additional dynamic playlists, special postings, and higher maximum lengths for messages associated with dynamic playlist item postings. Although the following discussion focuses on gifts of social currency with regard to dynamic playlists, it should be apparent that aspects of the invention related to social currency are not limited to dynamic playlists and can be applied in many other contexts, including social networking and blogging.

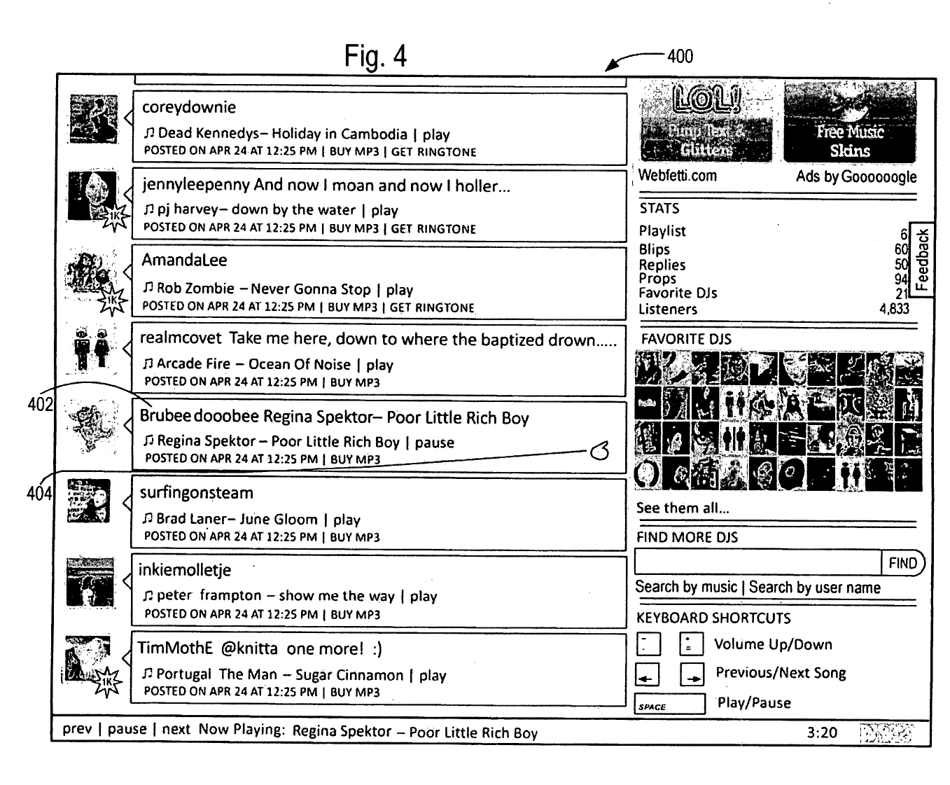

Referring to dynamic playlists, one user may choose to give another user a particular amount of social currency to indicate approval of or appreciation of the other user's choice of dynamic playlist items. In one embodiment, a follower user gives a publisher user a number of “props” to indicate that the follower user likes the publisher user's postings of dynamic playlist items generally, or that the follower user likes a particular posting of a dynamic playlist item by such publisher user (in which case, in addition to other associates, the giving of the “props” is associated with the particular posting of the dynamic playlist item). For example, FIG. 4 illustrates user interface 400 and dynamic playlist item 402. Dynamic playlist item 402 includes an interface icon 404, the selection of which results in a “props” being given to the publisher user that posted dynamic playlist item 402. A user may give a “props” to another user using other interface functions as well, such as by interacting with the other user's user profile. Also, a user does not need to be “following” another user in order to give the other user “props”. In another context, a user may give another user a particular amount of social currency to indicate approval of or appreciation of the other user's recent blog entries. For clarity, in the examples discussed below, a user who gives another user an amount of social currency will be referred to as the giver user, and the user who receives an amount of social currency from another will be referred to as the recipient user.

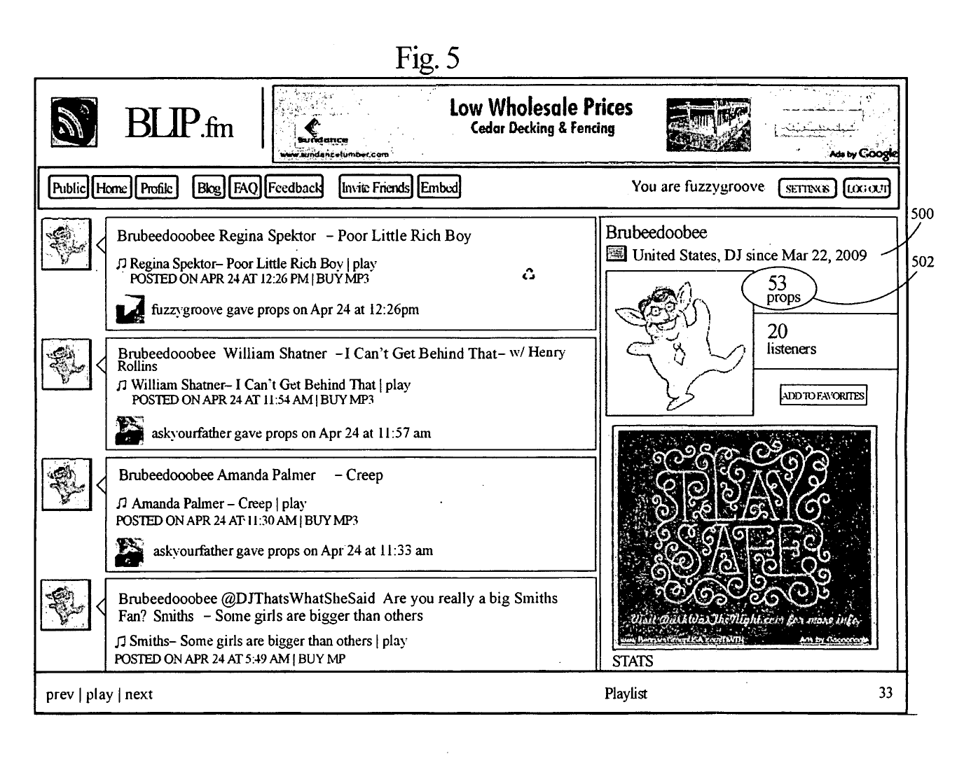

When a recipient user receives an amount of social currency from a giver user, the recipient user's lifetime social currency gift is increased by the amount of social currency received. For any user, an amount of lifetime social currency gift is maintained, and increases whenever a user receives a gift of social currency. For example, if a recipient user receives five “props” from a giver user, and if the recipient user's current lifetime social currency gift is 25 “props”, then the recipient user's lifetime social currency gift will be updated to 30 “props”. A user's lifetime social currency gift amount may be displayed in the profile of the user or in a dynamic playlist item that was posted by the user. For example, FIG. 5 illustrates user profile 500 that includes a display 502 of how many lifetime “props” the user in the profile has received. The display of a user's lifetime social currency gift amount readily indicates to other users how popular the user is within the social networking community in which the social currency gifts are given and received. For example, a user who has received over 10,000 “props” for his posted dynamic playlist items is probably posting dynamic playlist items that are popular with other users.

In one embodiment, an user can only give amounts of social currency, which may be denominated as “dollars”, “credits” or other denominations, that he or she “owns”. In this embodiment, each user is associated with an account that maintains the amount of social currency that is owned by the user. When a giver user gives an amount of social currency to a recipient user, the amount of social currency given is deducted from the giver user's account and added to the recipient user's account. A check may be performed to ascertain whether a giver user has at least the amount of social currency that he or she wishes to give to a recipient user. It should be noted that the amount of social currency that a user has in his or her account is different from the user's lifetime social currency gifts. A user's lifetime social currency gift does not decrease, and increases every time the user is given some amount of social currency.

In one embodiment, an user can increase the amount of social currency in his or her account by performing certain actions. In other words, a user can “earn” social currency. For example, in the dynamic playlist context, a user can “earn” a “props” for each dynamic playlist item that he or she posts. A user may also purchase social currency with actual currency (e.g., with a credit card payment). Once the amount of social currency is earned and added to a user's account, the user may give the social currency to other users. It should be noted that social currency “earned” by a user's performing of certain action is not reflected in the user's lifetime social currency gift because the user's lifetime social currency gift includes only amounts of social currency that were given to the user by other users.

According to another aspect of the invention, a user may create and modify certain tag settings. A user's tag settings are then used to filter a plurality of multimedia objects such that only the multimedia objects that satisfy the user's tag settings are provided to the user. This will also be referred to as “tag cloud tuning”. Although the following discussion focuses on tag cloud tuning with regards to dynamic playlists, it should be apparent that aspects of the invention related to tag cloud tuning are not limited to dynamic playlists and can be applied in many other contexts, including Internet radio.

Referring to dynamic playlists, a follower user may have selected many (e.g, 30) publisher users. In other words, according to an aspect of the invention described above, whenever any of the 30 publisher users posts a dynamic playlist item, the posted dynamic playlist item will be added to the follower's dynamic playlist, and will be eventually played in some order (e.g., reverse chronological order). A user may also indicate that all posted dynamic playlist items be added or his dynamic playlist. In other words, a user may choose to follow all publishers or a very large number of publishers, resulting in many dynamic playlist items being added to the user's dynamic playlist.

Although the follower user may be interested in listening to or watching most of the multimedia objects associated with the posted dynamic playlist items, the follower user may also wish to filter which multimedia objects are actually added to the dynamic playlist and/or played. The follower user may set up a filter by creating and modifying at least one tag setting that is used to filter the multimedia objects, where the multimedia objects are associated with tags.

It should be apparent to one skilled in the art that various items, including multimedia objects, blog entries, products, may be tagged with tags that indicate some information about the items. For example, a multimedia object that is an audio file may be tagged with “classical”, “punk”, “rap”, etc. These tags may be automatically generated based on identifiers associated with the multimedia objects (e.g., ID3 information associated with MP3 audio files) or based on the data contained within the multimedia objects themselves. In addition, users may create tags and associate the created tags with the multimedia objects. For example, a user may create a tag called “happy” and associate the “happy” tag with several multimedia objects. User-created tags and associations to multimedia objects, and may be retrieved in performing tag cloud tuning, or tag filtering.

Tag cloud tuning, or tag filtering, is performed for a particular user based on the particular user's tag settings. In other words, the particular user's tag settings are used to filter a plurality of multimedia objects. In the context of dynamic playlists, a follower user's tag settings are used to filter the stream of multimedia objects that are associated with the dynamic playlist items posted by the follower user's selected publisher users. A tag setting may be positive or negative. A positive tag indicates that a user wishes to receive multimedia objects tagged with the positive tag. A negative tag indicates that a user does not wish to receive multimedia objects tagged with the negative tag.

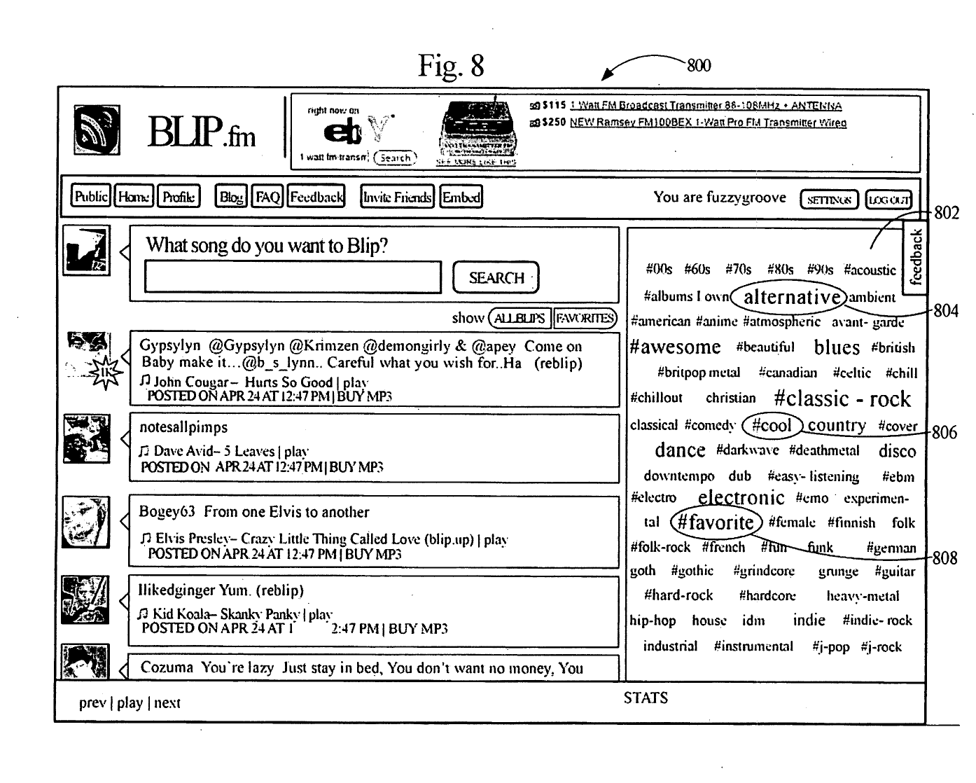

FIG. 8 illustrates an exemplary user interface 800 that includes tag cloud 802. Tag cloud 802 lists all the tags associated with multimedia objects of recently added dynamic playlist items. The recently added dynamic playlist items may comprise only the dynamic playlist items posted by a user's selected publishers or may comprise the dynamic playlist items posted by all publishers. The more multimedia objects are associated with a particular tag, the bigger the tag. For example, “alternative” tag 204 is big relative to the other tags (e.g., “#cool” tag 806 and “#favorite” tag 808) because there are more multimedia objects within the playlist being tuned that are associated with the “alternative” tag 804. In this example, a “#” indicates that the tag is user-created. If the playlist being tuned with tag cloud tuning is a dynamic playlist, the size of the tags may increase or decrease in real time, and certain tags may appear, disappear or reappear in the cloud based on the tags associated with dynamic playlist items being added to the dynamic playlist in real time. A user may interact with the tags in tag cloud 802 by clicking on the tags. In one embodiment, one click on a tag indicates that the user wishes to select that tag as a positive tag, and two clicks on a tag indicates that the user wishes to select that tag as a negative tag. A user may also remove a tag setting. For example, a third click on a tag may remove that tag from the tag settings.

In one embodiment, a user's tag settings are stored, so that upon login the user's stored tag settings may be retrieved and used to filter multimedia objects without the user having to re-enter all the tag settings. Multiple sets of tag settings may also be stored and named by the user (e.g. one set of stored tag settings named “Dance Music” and another set of stored tag settings named “Meditation Music”).

Methods and techniques described herein may be implemented by a conventional web application server or servers (e.g., an Apache web server with PHP and MySQL databases). Other implementations are also possible and the present invention is not limited to any particular web server architecture. User information and dynamic playlist item metadata (e.g., associated messages, tags, and locations of multimedia objects) may be stored on a central cluster of servers. Dynamic playlist items and associated metadata may be provided to various client devices through a website, an Application Programming Interface (API), etc. User credentials may be verified by the web application server so that appropriate public and/or personal dynamic playlist items may be displayed accordingly. Communications between the web application server(s) and client devices may be performed using the HTTP protocol or any other network protocols, such as XMPP or IRC.

Multimedia objects associated with dynamic playlist items may be stored centrally by the web application server(s) and/or distributed across third-party services throughout the internet. The client device is provided with metadata describing the multimedia objects, including the media type and location of multimedia objects, so that the client device may select one of several ways of obtaining a multimedia object for playing. One way of obtaining a multimedia object is to obtain the multimedia object from a central web application server(s) on which the multimedia object is stored. Another way of obtaining a multimedia object (e.g., a public MP3 file) may be to obtain the object from a third-party web server. Yet another way of obtaining a multimedia object (e.g., a private MP3 file) is to access the multimedia object through an API. For example, an audio file that is stored on an imeem (www.imeem.com) server may be accessed through imeem's native API, and a video file that is stored on an YouTube (www.youtube.com) server may be accessed through YouTube's native API. A media object that is no longer accessible at the indicated primary location may be automatically accessed via another location or service.

Although the present invention has been particularly described with reference to the preferred embodiments thereof, it should be readily apparent to those of ordinary skill in the art that changes and modifications in the form and details may be made without departing from the spirit and scope of the invention, It is intended that the appended claims encompass such changes and modifications.

What is claimed is:

1. A method comprising:
in response to receiving an indication that a first user has posted a dynamic playlist item associated with a multimedia object:
adding the dynamic playlist item to a dynamic playlist associated with a second user, the second user having selected the first user as a publisher; and
providing the dynamic playlist to the second user, the dynamic playlist comprising the dynamic playlist item created by the first user.

2. The method of claim 1, wherein the first user and the second user are the same user.

3. The method of claim 1, wherein the first user and the second user are different users.

4. The method of claim 1, further comprising:
in response to receiving an indication that the second user has selected a third user as another publisher, storing, in a computer-readable storage medium, data indicating that the second user has selected the third user as a publisher;
in response to receiving an indication that the third user has created another dynamic playlist item associated with another multimedia object, adding the other dynamic playlist item to the dynamic playlist associated with the second user after determining, based on the data stored in the computer-readable storage medium, that the second user has selected the third user as a publisher; and
providing the dynamic playlist to the second user, the dynamic playlist comprising the other dynamic playlist item created by the third user.

5. The method of claim 4, wherein the indication that the second user has selected a third user as another publisher is received from the second user.

6. The method of claim 4, wherein the indication that the second user has selected a third user as another publisher is received from a social network on which the third user is associated with the second user as a friend.

7. The method of claim 1, wherein providing comprises sending, to a client device associated with the second user, data for displaying the dynamic playlist on the client device.

8. The method of claim 7, wherein the client device is a personal computer (PC).

9. The method of claim 8, wherein the data for displaying the dynamic playlist comprises data that can be displayed on a web page.

10. The method of claim 7, wherein the client device is one of: a mobile telephone, a gaming device, and a television set-top box.

11. The method of claim 1, wherein providing comprises sending, to a client device associated with the second user, a currently playing multimedia object associated with a currently playing dynamic playlist item of the dynamic playlist.

12. The method of claim 11, wherein sending the currently playing multimedia object to the client device associated with the second user, the currently playing multimedia object comprises streaming data contained in the currently playing multimedia object to the client device.

13. The method of claim 12, wherein the currently playing multimedia object comprises audio data.

14. The method of claim 12, wherein the currently playing multimedia object comprises video data.

15. The method of claim 11, wherein the currently playing dynamic playlist item is a dynamic playlist item that has most recently been added to the dynamic playlist.

16. The method of claim 1, wherein:
the dynamic playlist item comprises an accompanying note, the accompanying note received from the first user; and
providing comprises providing the accompanying note to the second user.

17. The method of claim 1, wherein:
the dynamic playlist item comprises an avatar and a user name of the first user; and
providing comprises providing the avatar and the user name to the second user.

18. The method of claim 1, wherein:
the dynamic playlist item comprises information about the multimedia object; and
providing comprises providing the information about the multimedia object to the second user.

19. The method of claim 1, wherein adding the dynamic playlist item to the dynamic playlist associated with the second user comprises prepending the dynamic playlist item to the dynamic playlist associated with the second user.

20. The method of claim 19, wherein dynamic playlist items in the dynamic playlist are sorted in a reverse chronological order.

21. The method of claim 11, wherein the step of sending is performed in response to receiving, from the second user, a request to play the dynamic playlist.

22. The method of claim 11, wherein the step of sending is stopped in response to receiving, from the second user, a request to stop playing the dynamic playlist.

23. The method of claim 1, further comprising:
in response to receiving, from the second user, a request to play a particular dynamic playlist item on the dynamic playlist,
sending, to a client device associated with the second user, a multimedia object associated with the particular dynamic playlist item.

24. The method of claim 11, further comprising:
in response to receiving, from the second user, a request to play a next dynamic playlist item on the dynamic playlist, performing the steps of:
stopping the sending of the currently playing multimedia object; and
sending, to the client device, a multimedia object associated with a next dynamic playlist item that is listed immediately after the currently playing dynamic playlist item in the dynamic playlist.

25. The method of claim 11, further comprising:
in response to receiving, from the second user, a request to play a next dynamic playlist item on the dynamic playlist, performing the steps of:
stopping the sending of the currently playing multimedia object; and
sending, to the client device, a multimedia object associated with a previous dynamic playlist item that is listed immediately before the currently playing dynamic playlist item in the dynamic playlist.

26. The method of claim 1, further comprising:
in response to receiving, from the second user, a reply message corresponding to the dynamic playlist item, sending the reply message to the first user.

27. The method of claim 1, further comprising:
in response to receiving an indication that the second user has selected the dynamic playlist item for reposting, performing the steps of:
posting a reposted dynamic playlist item to the dynamic playlist associated with the second user, the reposted dynamic playlist item associated with the multimedia object and comprising a user name of the first user;
providing the dynamic playlist to the second user, the dynamic playlist comprising the reposted dynamic playlist item;
adding the reposted dynamic playlist item to a dynamic playlist associated with a third user that has selected the second user as a publisher; and
providing the dynamic playlist associated with the third user to the third user, the dynamic playlist associated with the third user comprising the reposted dynamic playlist item.

28. The method of claim 7, wherein:
the data for displaying comprises data for displaying a purchase link, an interaction with the purchase link resulting in the display of a web page on which a product that corresponds to the multimedia object associated with the dynamic playlist item can be purchased.

29. The method of claim 1, further comprising:
in response to receiving, from the second user, a request to add a particular dynamic playlist item of the dynamic playlist to a static playlist, adding the particular dynamic playlist item to the static playlist as a static playlist item;
in response to receiving, from the second user, a request to play the static playlist item from the static playlist, sending, to a client device associated with the second user, a multimedia object associated with the static playlist item.

30. The method of claim 1, further comprising:
in response to receiving a query from the second user, generating a list of query results, each query result corresponding to a query result multimedia object;
providing the list of query results to the second user;
in response to receiving an indication that the second user has selected a particular query result from the list of query results, providing an interface to the second user that allows the second user to post a dynamic playlist item that is associated with the query result multimedia object corresponding to the particular query result.

31. A method comprising:
in response to receiving an indication that a first user wishes to give a second user a particular amount of social currency, performing the steps of:
updating the second user's lifetime social currency gifts to include the particular amount of social currency;
updating an amount in the second user's social currency account to include the particular amount of social currency;
updating an amount in the first user's social currency account to exclude the particular amount of social currency.

32. The method of claim 31, further comprising:
generating display data for displaying a user profile of the second user, the display data comprising the second user's lifetime social currency gifts.

33. The method of claim 31, further comprising:
in response to receiving an indication that the second user has completed an action that is associated with an amount of earned social currency, updating the amount in the second user's social currency account to include the amount of earned social currency.

34. The method of claim 31, further comprising:
in response to receiving an indication that a first user wishes to give a second user a particular amount of social currency, performing a check to determine whether the first user has at least the particular amount of social currency in the first user's social currency account;
wherein the steps of updating the second user's lifetime social currency gifts, updating the second user's social currency account, and updating the first user's social currency account are performed only in response to determining that the first user has at least the particular amount of social currency in the first user's social currency account.

35. A method comprising:
identifying a multimedia object, of a plurality of multimedia objects, in a multimedia data stream, based on at least one tag associated with the multimedia object and at least one tag setting associated with a user; and
providing the identified multimedia object to the user.

36. The method of claim 35, wherein providing the identified multimedia object to the user comprises sending, to a client device associated with the user, the identified multimedia object.

37. The method of claim 35, wherein providing the identified multimedia object to the user comprises streaming, to a client device associated with the user, data contained in the identified multimedia object to the client device.

38. The method of claim 35, wherein the identified multimedia object comprises audio data.

39. The method of claim 35, wherein the identified multimedia object comprises video data.

40. The method of claim 35, wherein:
the at least one tag setting associated with the user indicates a particular negative tag; and
the step of identifying comprises filtering multimedia objects in the plurality of multimedia objects such that the identified multimedia object is not associated with the negative tag.

41. The method of claim 35, wherein:
the at least one tag setting associated with the user indicates a particular positive tag; and
the step of identifying comprises filtering multimedia objects in the plurality of multimedia objects such that the identified multimedia object is associated with the positive tag.

42. The method of claim 35, wherein the at least one tag is automatically generated based on at least one identifier associated with the multimedia object.

43. The method of claim 35, wherein the at least one tag is a user-created tag for the multimedia object.

44. The method of claim 35, wherein the at least one tag setting associated with the user is retrieved in response to the user providing login information.

45. An apparatus for providing dynamic playlists, the apparatus comprising a server that is configured to:
in response to receiving an indication that a first user has posted a dynamic playlist item associated with a multimedia object:
add the dynamic playlist item to a dynamic playlist associated with a second user, the second user having selected the first user as a publisher; and
provide the dynamic playlist to the second user, the dynamic playlist comprising the dynamic playlist item created by the first user.

46. An apparatus for providing dynamic playlists, the apparatus comprising a server that is configured to:
in response to receiving an indication that a first user wishes to give a second user a particular amount of social currency, performing the steps of:
update the second user's lifetime social currency gifts to include the particular amount of social currency;
update an amount in the second user's social currency account to include the particular amount of social currency;
update an amount in the first user's social currency account to exclude the particular amount of social currency.

47. An apparatus for providing dynamic playlists, the apparatus comprising a server that is configured to:
identify a multimedia object, of a plurality of multimedia objects, in a multimedia data stream, based on at least one tag associated with the multimedia object and at least one tag setting associated with a user; and
provide the identified multimedia object to the user.
